(19) United States
(12) Patent Application Publication
(10) Pub. No.: US 2022/0276050 A1
(43) Pub. Date: Sep. 1, 2022

(54) SURVEY INFORMATION MANAGING SYSTEM

(71) Applicant: TOPCON CORPORATION, Tokyo (JP)

(72) Inventor: Takeshi KIKUCHI, Tokyo (JP)

(21) Appl. No.: 17/667,163

(22) Filed: Feb. 8, 2022

(30) Foreign Application Priority Data
Mar. 1, 2021 (JP) 2021-031372

(51) Int. Cl. G01C 15/06; G01C 15/00; G06V 20/20; G06V 30/228; G02B 27/01; G06T 19/00

(52) U.S. Cl. CPC G01C 15/06; G01C 15/006; G06V 20/20; G06V 30/228; G02B 27/017; G06T 19/006; G02B 2027/0178

(57) ABSTRACT

A managing system includes an electronic marker to be used near a measurement point, including a position sensor, a posture sensor, a communication section, and a marker operation button group, an eyewear device to be worn on the head of the worker, including a display, an imaging section, a position sensor, a posture sensor, and a communication section, an arithmetic device for synchronizing positions and postures of the electronic marker and the eyewear device, displaying a handwritten data synthesized image obtained by synthesizing the handwritten data written at coordinates of a tip end port of the electronic marker of the marker operation button group with an image imaged by the imaging section, and applying OCR processing to the handwritten data synthesized image, and a storage device for storing the handwritten data synthesized image and text data extracted by the OCR processing as additional data of the measurement point.

### TECHNICAL FIELD

The present invention relates to a system for managing survey information of a measurement point.

### BACKGROUND ART

In a survey work accompanying civil engineering and construction, a worker designates a measurement point by using a target, etc., and a surveying instrument (total station) surveys (measures a distance and an angle to) the measurement point. As for recent surveying instruments, when the surveying instrument points toward the approximate measurement point, it automatically collimates the measurement point, so that a worker can perform a survey individually while moving among measurement points (for example, Patent Literature 1).

### CITATION LIST

### Patent Literature

Patent Literature 1: Japanese Published Unexamined Patent Application No. 2009-229192

### SUMMARY OF INVENTION

### Technical Problem

Three-dimensional position data of a measurement point of a survey performed by a worker is usually transmitted to an administrator other than the worker and subjected to post-processing such as analysis and report creation by the administrator. At this time, the administrator checks not only the three-dimensional position data but also photographs of the site and refers to notes made by the worker in order to know the measurement point, and management of this information is complicated.

The present invention was made to solve the problem described above, and an object thereof is to provide a survey information managing system for managing survey information other than three-dimensional position data of a measurement point, as evidence of the measurement point.

### Solution to Problem

In order to solve the problem described above, a survey information managing system according to an aspect of the present invention includes an electronic marker to be used near a measurement point by a worker, including a position sensor, a posture sensor, a communication section, and a marker operation button group for inputting handwritten data, an eyewear device to be worn on the head of the worker, including a display configured to cover the eyes of the worker, an imaging section configured to perform imaging in a line-of-sight direction of the worker, a position sensor, a posture sensor, and a communication section, an arithmetic device configured to communicate with the electronic marker and the eyewear device, synchronize positions and postures of the electronic marker and the eyewear device, cause the display to display a handwritten data synthesized image obtained by synthesizing the handwritten data written at coordinates of a tip end port of the electronic marker by operation of the marker operation button group with an image imaged by the imaging section of the eyewear device, and apply OCR processing to the handwritten data synthesized image, and a storage device configured to store the handwritten data synthesized image and text data extracted by the OCR processing from the handwritten data synthesized image, as additional data of the measurement point.

In the aspect described above, it is also preferable that the survey information managing system further includes a surveying instrument including a distance-measuring section capable of performing a non-prism distance measuring of the measurement point by distance-measuring light, an imaging section configured to perform imaging in an optical axis direction of the distance-measuring light, an angle-measuring section configured to measure a vertical angle and a horizontal angle at which the distance-measuring section is oriented, a drive section configured to drive the vertical angle and the horizontal angle of the distance-measuring section to set angles, and a communication section, wherein the surveying instrument acquires three-dimensional position data of the measurement point, and for the same measurement point, the storage device stores the three-dimensional position data and the additional data by associating these data with the same identification ID.

In the aspect described above, it is also preferable that the survey information managing system further includes a display section, wherein on the display section, as survey information of the measurement point, the three-dimensional position data, the text data, and the handwritten data synthesized image are displayed on one screen.

### Advantageous Effects of Invention

According to the present invention, a technology for managing survey information other than three-dimensional position data of a measurement point as evidence can be provided.

### BRIEF DESCRIPTION OF DRAWINGS

FIG. 1 is a configuration block diagram of a survey information managing system according to an embodiment of the present invention.

FIG. 2A is a perspective view of a surveying instrument related to the same managing system.

FIG. 2B is a configuration block diagram of the surveying instrument.

FIG. 3A is a perspective view of an electronic marker related to the same managing system.

FIG. 3B is a configuration block diagram of the electronic marker.

FIG. 4A is a perspective view of an eyewear device related to the same managing system.

FIG. 4B is a configuration block diagram of the eyewear device.

FIG. 5 is a configuration block diagram of a processing device related to the same managing system.

FIG. 6A illustrates an image of use of the same managing system at a survey site, when acquiring three-dimensional position data FIG. 6B illustrates an image of use of the same managing system at a survey site when acquiring additional data.

FIG. 7 is a diagram illustrating an example of a survey information database.

FIG. 8 illustrates an example of a management screen to be displayed on the processing device.

FIG. 9A is a configuration block diagram of a managing system according to a modification when the eyewear device includes an arithmetic device and a storage device.

FIG. 9B is a configuration block diagram of a managing system according to a modification when the electronic marker includes an arithmetic device and a storage device.

### DESCRIPTION OF EMBODIMENTS

Next, a preferred embodiment of the present invention will be described with reference to the drawings.

### 1. Embodiment

1-1. Configuration of Managing System

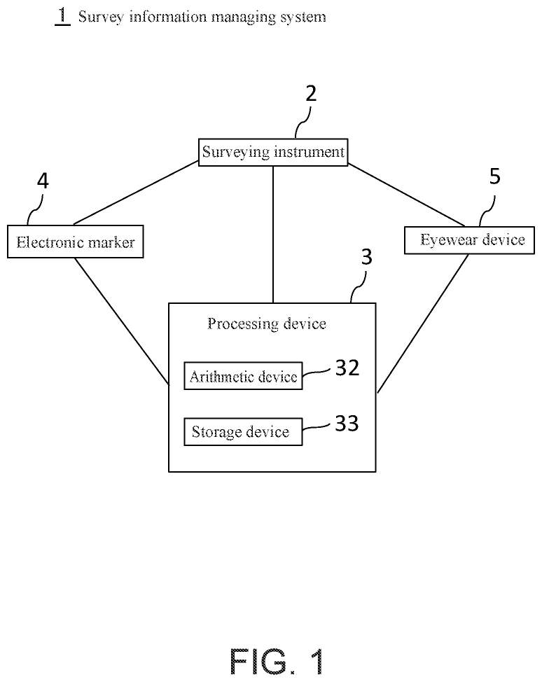

FIG. 1 is a configuration block diagram of a survey information managing system according to an embodiment of the present invention. A survey information managing system 1 (hereinafter, simply referred to as managing system 1) includes a surveying instrument 2, a processing device 3, an electronic marker 4, and an eyewear device 5.

In the managing system 1, the surveying instrument 2, the processing device 3, the electronic marker 4, and the eyewear device 5 can wirelessly communicate with each other. The processing device 3 includes an arithmetic device 32 (described later) that synchronizes the surveying instrument 2, the electronic marker 4, and the eyewear device 5 and performs various processes, and a storage device 33 (described later) that stores survey information.

In this description, survey information means a latitude, a longitude, and an elevation (three-dimensional position data) of a measurement point, and additional information (additional data) related to a survey of the measurement point.

First, configurations of the surveying instrument 2, the processing device 3, the electronic marker 4, and the eyewear device 5 will be described. Among these, to acquire additional data, the processing device 3, the electronic marker 4, and the eyewear device 5 are used. To acquire three-dimensional position data, the surveying instrument 2, the processing device 3, the electronic marker 4, and the eyewear device 5 are used. In acquisition of additional data, the surveying instrument 2 is an optional element.

1-2. Configuration of Surveying Instrument

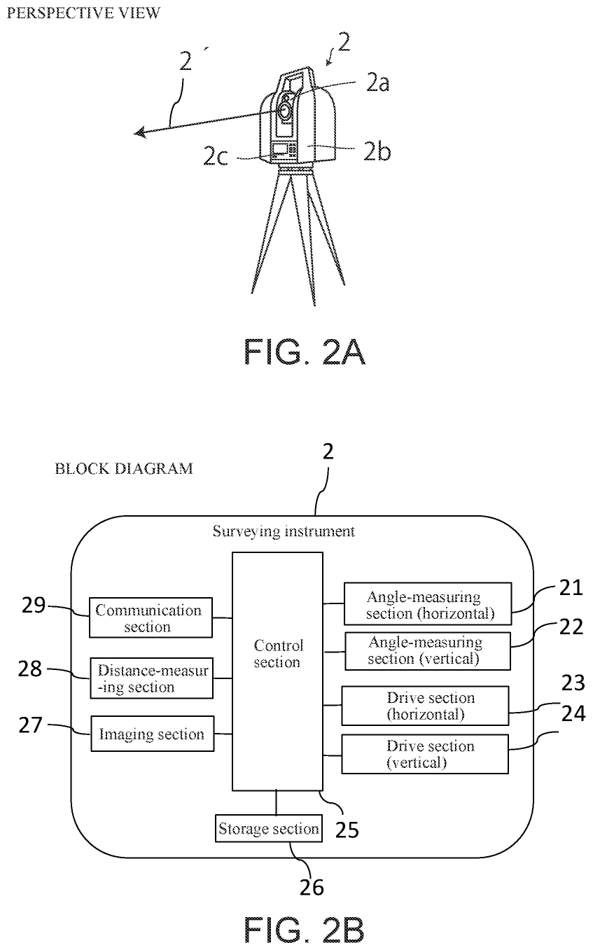

The surveying instrument 2 is installed at the survey site by using a tripod. FIG. 2A is a perspective view of the surveying instrument 2, and FIG. 2B is a configuration block diagram of the surveying instrument 2. The surveying instrument 2 includes, in order from the lower side, a leveling section, a base portion provided on the leveling section, a bracket portion 2b that rotates horizontally on the base portion, and a telescope 2a that rotates vertically at a center of the bracket portion 2b. The surveying instrument 2 is a motor-driven total station, and includes angle-measuring sections 21 and 22, drive sections 23 and 24, a control section 25, a storage section 26, an imaging section 27, a distance-measuring section 28, and a communication section 29. The elements 21, 22, 23, 24, 25, 26, and 29 are housed in the bracket portion 2b, and the distance-measuring section 28 and the imaging section 27 are housed in the telescope 2a. The surveying instrument 2 also includes a display operation section 2c.

The angle-measuring sections 21 and 22 are encoders. The angle-measuring section 21 detects a horizontal angle of rotation of the bracket portion 2b. The angle-measuring section 22 detects a vertical angle of rotation of the telescope 2a. The drive sections 23 and 24 are motors. The drive section 23 horizontally rotates the bracket portion 2b, and the drive section 24 vertically rotates the telescope 2a. By cooperative operation of the drive sections 23 and 24, the orientation of the telescope 2a is changed.

The distance-measuring section 28 includes a light transmitting section and a light receiving section, and emits distance-measuring light 2′, for example, infrared pulsed laser, etc., and measures a distance from a phase difference between the distance-measuring light 2′ and internal reference light. The distance-measuring section 28 can perform both of a reflection prism distance measuring in which a distance to a prism is measured by causing the distance-measuring light 2′ to be reflected by the prism, and a non-prism distance measuring in which a distance to an object other than a prism is measured by irradiating the object with the distance-measuring light 2′. The imaging section 27 is an image sensor (for example, a CCD sensor or CMOS sensor). The imaging section 27 is configured integrally with the distance-measuring section 28 inside the telescope 2a, and images an image in an optical axis direction of the distance-measuring light 2′. The communication section 29 has communication standards equivalent to those of, for example, a communication section 31 (described later) of the processing device 3.

The control section 25 includes a CPU (Central Processing Unit), and performs, as controls, information transmission and reception through the communication section 29, respective rotations by the drive sections 23 and 24, distance measuring by the distance-measuring section 28, angle measuring by the angle-measuring sections 21 and 22, and imaging by the imaging section 27. The storage section 26 includes a ROM (Read Only Memory) and a RAM (Random Access Memory). In the ROM, programs for the control section 25 are stored, and are read by the RAM to execute the respective controls. Three-dimensional position data (distance measuring/angle measuring) acquired through a survey by the surveying instrument 2 are recorded in the processing device 3 described later.

1-3. Configuration of Electronic Marker

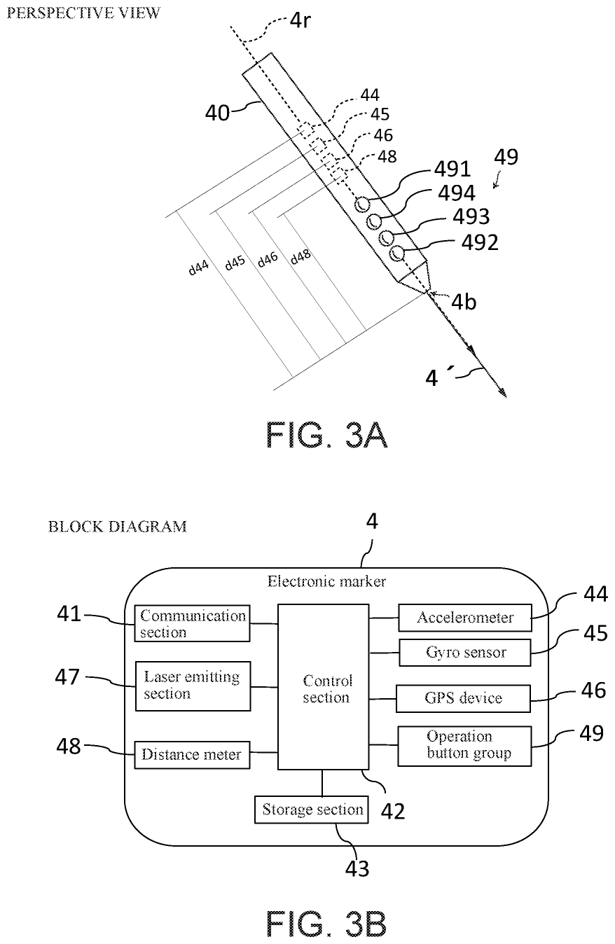

The electronic marker 4 is carried by a worker and used near a measurement point. FIG. 3A is a perspective view of the electronic marker 4, and FIG. 3B is a configuration block diagram of the electronic marker 4. The electronic marker 4 includes a stick body 40 having a length that a worker can hold by hand and handle, and a tip end port 4b on its tip end. The electronic marker 4 includes a communication section 41, a control section 42, a storage section 43, an accelerometer 44, a gyro sensor 45, a GPS device 46, a laser emitting section 47, a distance meter 48, and a marker operation button group 49.

The communication section 41 has communication standards equivalent to those of, for example, the communication section 31 (described later) of the processing device 3. The accelerometer 44 detects accelerations in three-axis directions of the electronic marker 4. The gyro sensor 45 detects rotations around three axes of the electronic marker 4. The accelerometer 44 and the gyro sensor 45 are the “posture sensors” of the electronic marker 4 in the claims. The GPS device 46 detects a position of the electronic marker 4 based on a signal from a GPS (Global Positioning System). The GPS device 46 is the “position sensor” of the electronic marker 4 in the claims. The GPS device 46 may use positioning information obtained by a GNSS, a quasi-zenith satellite system, GALILEO, or GLONAS.

The laser emitting section 47 is used when acquiring three-dimensional position data, and is an optional element in acquisition of additional data. The laser emitting section 47 includes a light source and a light emission control IC for the light source, and linearly emits laser light 4′ in visible color in an axial direction of the stick body 40 of the electronic marker 4 (hereinafter, the direction is identified as a direction toward the tip end port 4b and referred to as a marker axial direction 4r) from the tip end port 4b.

The distance meter 48 is used when acquiring three-dimensional position data, and is an optional element in acquisition of additional data. The distance meter 48 includes a light transmitting section and a light receiving section, emits distance-measuring light (not illustrated), for example, infrared pulsed laser, etc., from the light transmitting section, and measures a distance from the tip end port 4b to the measurement point based on a time to light reception and light speed. The distance meter 48 is housed so that an optical axis matches an optical axis of the laser light 4′.

The marker operation button group 49 is provided as physical switches on, for example, a side surface of the stick body. The marker operation button group 49 includes at least a measurement button 491 for instructing a survey, a write button 492 for inputting “handwritten data (described later),” an erase button 493, and an edit button 494. When the measurement button 491 is pressed, the surveying instrument 2, the processing device 3, the electronic marker 4, and the eyewear device 5 work in cooperation with each other to acquire three-dimensional position data of a measurement point. A worker leaves additional data by operating the write button 492, the erase button 493, and the edit button 494. The write button 492 and the erase button 493 have a pen function. The edit button 494 has a function to edit the pen function.

The control section 42 includes a CPU, and performs, as controls, emission of laser light 4′, information detection from the posture sensor 44, 45 and the position sensor 46, information transmission through the communication section 41, and calculation of a posture and a position of the tip end port 4b (described later). The storage section 43 includes a ROM and a RAM, and enables the respective controls of the control section 42.

Here, the elements 41, 42, 43, 44, 45, 46, 47, and 48 are configured by using a dedicated module and IC configured by using integrated-circuit technology. Inside the stick body 40 of the electronic marker 4, the elements 44, 45, 46, and 48 are disposed on the marker axial direction 4r, and positional relationships of these with the tip end port 4b (separating distances d44, d45, d46, and d48 from the tip end port 4b) are measured and stored in advance in the storage section 43. However, when positional relationships with the marker axial direction 4r are measured and stored in advance, these elements may be displaced away from the marker axial direction 4r.

1-4. Configuration of Eyewear Device

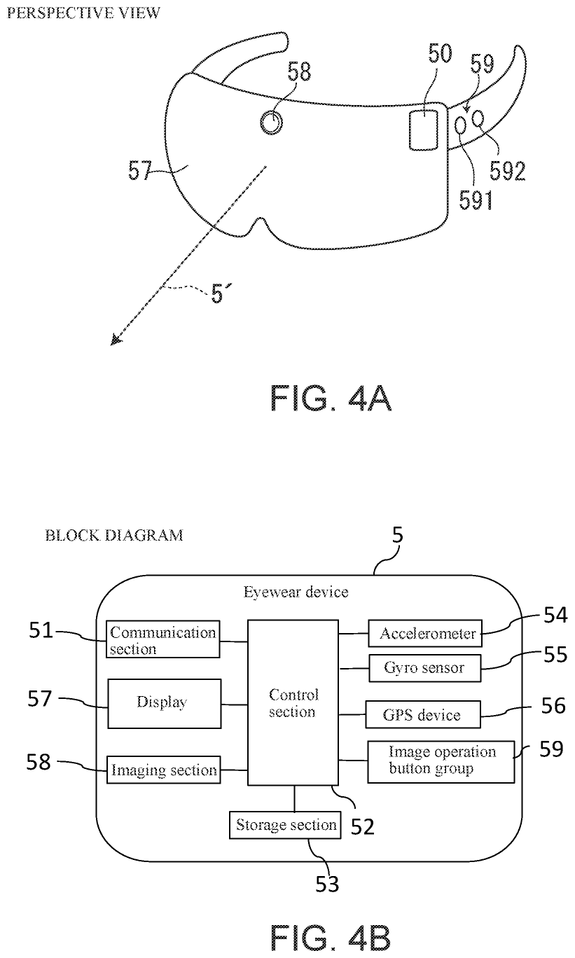

The eyewear device 5 is an eyeglasses-type image display device to be worn on the head of a worker. FIG. 4A is a perspective view of the eyewear device 5, and FIG. 4B is a configuration block diagram of the eyewear device 5. The eyewear device 5 includes a communication section 51, a control section 52, a storage section 53, an accelerometer 54, a gyro sensor 55, a GPS device 56, a display 57, an imaging section 58, and an image operation button group 59. Here, the elements 51, 52, 53, 54, 55, and 56 are configured by using a dedicated module and IC configured by using integrated-circuit technology, and are housed in a processing BOX 50 at an arbitrary position.

The communication section 51 has communication standards equivalent to those of, for example, the communication section 31 (described later) of the processing device 3. The display 57 is a liquid crystal or organic EL screen, and is disposed to cover the eyes of a worker. The accelerometer 54, the gyro sensor 55, and the GPS device 56 are equivalent to those of the electronic marker 4. The imaging section 58 is an image sensor (for example, a CCD sensor or CMOS sensor), and has a zoom function to be realized by optical or digital processing. The imaging section 58 is disposed at an upper portion central position of the display 57, and by setting this central position as an origin, the imaging section 58 can perform imaging in a worker's line-of-sight direction (reference sign 5′) at a wide angle in up-down and left-right directions of the origin.

The image operation button group 59 is provided as physical switches on, for example, a temple portion of the device. The image operation button group 59 includes at least an image save button 591 for leaving additional data of a survey and a zoom button 592 for operating the zoom function of the imaging section 58.

The control section 52 includes a CPU, and performs, as controls, information detection from the posture sensor 54, 55 and the position sensor 56, information transmission and reception through the communication section 51, imaging by the imaging section 58, and display of written data (described later) on the display 57. The storage section 53 includes a ROM and a RAM, and enables the respective controls of the control section 52.

1-5. Configuration of Processing Device

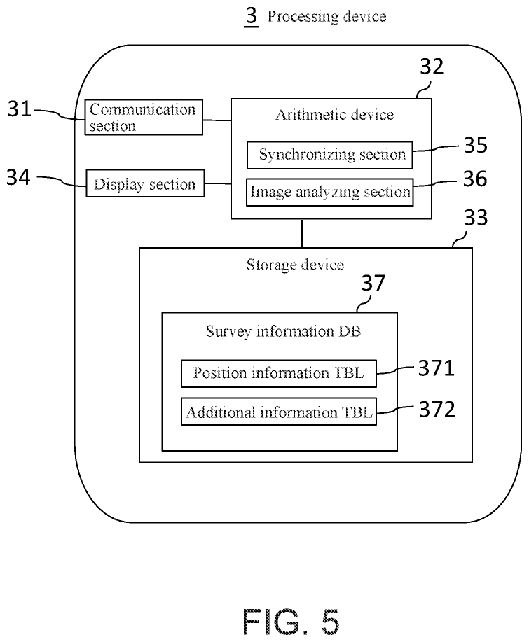

The processing device 3 may be at an arbitrary location in the survey site. The processing device 3 is a general-purpose personal computer, dedicated hardware configured by PLD (Programmable Logic Device), etc., or a high-performance tablet terminal, etc. FIG. 5 is a configuration block diagram of the processing device 3. The processing device 3 includes at least the communication section 31, the arithmetic device 32, the storage device 33, and a display section 34.

The communication section 31 can wirelessly communicate with the communication section 29 of the surveying instrument 2, the communication section 41 of the electronic marker 4, and the communication section 51 of the eyewear device 5. For the communication, any one of or a combination of Bluetooth (registered trademark), various wireless LAN standards, infrared communication, mobile phone lines, and other wireless lines, etc., can be used.

The arithmetic device 32 includes a high-performance CPU, and a synchronizing section 35 and an image analyzing section 36 are configured by software. The synchronizing section 35 receives position and posture information of the surveying instrument 2, position and posture information of (tip end port 4b of) the electronic marker 4, and position and posture information of the eyewear device 5, and synchronizes a coordinate space of the surveying instrument 2, a coordinate space of the electronic marker 4, and a coordinate space of the eyewear device 5 (described later). The image analyzing section 36 performs image analysis for images received from the surveying instrument 2 and the eyewear device 5 for acquiring three-dimensional position data, and performs image analysis for the “handwritten data synthesized image (described later)” received from the eyewear device 5 for acquiring additional data.

The storage device 33 includes a high-capacity storage medium such as an HDD, and includes a survey information database 37 for managing survey information. The survey information database 37 includes a position information table 371 for managing three-dimensional position data of a measurement point, and an additional information table 372 for managing additional data (described later).

1-6. Synchronization of Managing System

Before starting a measurement, synchronization of the managing system 1 (the surveying instrument 2, the processing device 3, the electronic marker 4, and the eyewear device 5) is performed. The synchronization is a work to enable grasping of respective positions and postures of the instruments of the surveying instrument 2, the electronic marker 4, and the eyewear device 5 in the same coordinate space. Hereinafter, an example considered to be preferred will be described, however, the synchronization may be performed by a method based on the knowledge of a person skilled in the art.

First, for the managing system 1, a reference point and a reference direction are set in the survey site, and the surveying instrument 2 and the processing device 3 are synchronized. As for the reference point, a known coordinate point (point at known coordinates) or an arbitrary point at the site is selected. As for the reference direction, a characteristic point different from the reference point is arbitrarily selected, and a direction from the reference point to the characteristic point is selected. Then, by observation such as backward intersection using points including the reference point and the characteristic point, a three-dimensional position of the surveying instrument 2 is grasped, and information on the three-dimensional position is transmitted to the processing device 3. The synchronizing section 35 of the processing device 3 recognizes (x, y, z)=(0, 0, 0) as absolute coordinates of the reference point, and recognizes a horizontal angle of 0 degrees as the reference direction. Thereafter, related to information from the surveying instrument 2, the arithmetic device 32 (synchronizing section 35) grasps a position and a posture of the surveying instrument 2 in a coordinate system with an origin set at the reference point.

Next, the electronic marker 4 is synchronized with the processing device 3, and the eyewear device 5 is synchronized with the processing device 3. With respect to the electronic marker 4, in a state where the electronic marker 4 is installed at the reference point, zero coordinates of the GPS device 46 are set to the reference point, and the electronic marker 4 is leveled, the direction of emission of the laser light 4′ of the electronic marker 4 is set in the reference direction, and the reference posture of the electronic marker 4 is aligned with the reference direction. Similarly, with respect to the eyewear device 5, in a state where the eyewear device 5 is installed at the reference point, zero coordinates of the GPS device 56 are set to the reference point, and the eyewear device 5 is leveled, the line-of-sight direction 5′ is set in the reference direction, and a reference posture of the eyewear device 5 is aligned with the reference direction. Thereafter, related to information from the electronic marker 4 and the eyewear device 5, the arithmetic device 32 (synchronizing section 35) grasps positions and postures of these instruments in a space with an origin set at the reference point.

Alternatively, for synchronization between the electronic marker 4 and the eyewear device 5, the surveying instrument 2 may be used. For example, it is also possible that the electronic marker 4 and the eyewear device 5 are brought closer to the surveying instrument 2, zero coordinates of the GPS devices 46 and 56 are set to coordinates of the surveying instrument 2, and in a horizontal state, a direction of emission of laser light 4′ of the electronic marker 4 and the line-of-sight direction 5′ of the eyewear device 5 are aligned with distance-measuring light 2′ of the surveying instrument 2.

1-7. Managing Method

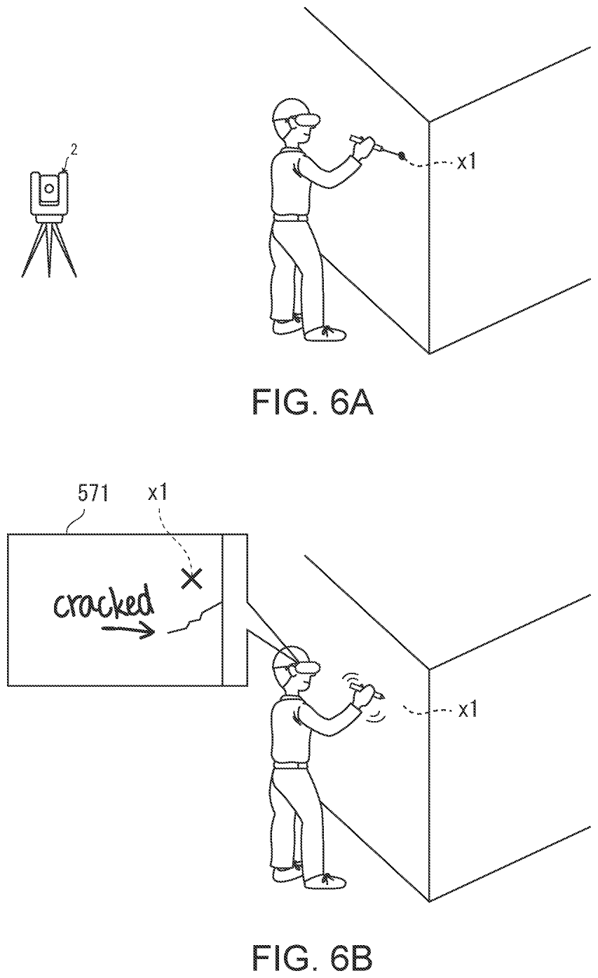

Next, management of survey information of a measurement point by using the managing system 1, will be described. FIGS. 6A and 6B illustrate images of use of the managing system 1 at a survey site, and FIG. 6A illustrates an image when acquiring three-dimensional position data, and FIG. 6B illustrates an image when acquiring additional data.

First, a worker wears the eyewear device 5 on his/her head, carries the electronic marker 4 by hand, and moves to the measurement point x1 that the worker wants to measure.

1-7-1. Acquisition of Three-Dimensional Position Data

When acquiring three-dimensional position data of a measurement point, as illustrated in FIG. 6A, the worker irradiates the measurement point x1 with the laser light 4′ of the electronic marker 4 while visually recognizing the measurement point x1 through the eyewear device 5, and presses the measurement button 491.

When the measurement button 491 is pressed, the electronic marker 4 calculates position and posture information of the tip end port 4b and a distance measuring value of the distance meter 48, the eyewear device 5 images an image including the measurement point x1, and the information and image are transmitted to the processing device 3. Based on the information from the electronic marker 4, the processing device 3 calculates an approximate three-dimensional position of the measurement point x1 by offset observation in a three-dimensional coordinate system with an origin set at the reference point, and causes the surveying instrument 2 to image an image of the approximate three-dimensional position. The processing device 3 identifies an end point position of the image of the laser light 4′ in the three-dimensional coordinate system with the origin set at the reference point by image processing described later, performs a non-prism measuring (distance measuring and angle measuring) of the end point position of the image of the laser light 4′ by the surveying instrument 2, and acquires three-dimensional position data (latitude, longitude, and elevation) of the measurement point x1. For acquiring the three-dimensional position data, the image analyzing section 36 of the processing device 3 compares the image acquired by the eyewear device 5 and the image acquired by the surveying instrument 2 by a known image matching technology, and identifies the end point position of the image of the laser light 4′. The image used herein, acquired by the eyewear device 5, is either an image imaged by the imaging section 58 of the eyewear device 5 when the measurement button 491 is pressed, or an image acquired by the imaging section 58 with which “handwritten data” is not synthesized in “1-7-2. Acquisition of additional data” described below.

Here, for acquiring the three-dimensional position data, an automatic measuring method to be realized by cooperative operation of the surveying instrument 2, the processing device 3, the electronic marker 4, and the eyewear device 5 has been described, however, the method is not limited to this. The three-dimensional position data may be measured by automatic tracking or automatic collimation of the surveying instrument 2 by using a target, a prism, etc., in a conventional manner.

1-7-2. Acquisition of Additional Data

When the worker wants to leave additional data of the measurement point, as illustrated in FIG. 6B, the worker writes “handwritten data” in a space through the display 57 of the eyewear device 5 with the electronic marker 4.

The electronic marker 4 can calculate a posture (marker axial direction 4r) of the tip end port 4b from the accelerometer 44 and the gyro sensor 45, and calculate a three-dimensional position of the tip end port 4b by offsetting position information acquired by the GPS device 46 by a known separating distance d46 in the marker axial direction 4r. The postures and positions of the electronic marker 4 and the eyewear device 5 are synchronized with each other, so that the synchronizing section 35 of the processing device 3 can identify coordinates of the tip end port 4b of the electronic marker 4 on the display 57 of the eyewear device 5.

The worker handwrites characters and figures in the air near the measurement point x1 by using a pen point (tip end port 4b) of the electronic marker 4 while the write button 492 is pressed. On the display 57 of the eyewear device 5, loci of movement (lines connecting coordinate point sequences) of the tip end port 4b of the electronic marker 4 while the write button 492 is pressed are synthesized with the image imaged by the imaging section 58 and displayed.

When the erase button 493 is pressed, the last locus is erased. When the edit button 494 is pressed, a pen color, a thickness, and a line style, etc., of loci to be displayed are changed. From the edit button 494, standard characters such as “1,” “2,” “3,” “A,” “B,” “C,” and “+” and “−,” or “!” and “&” or figures such as circles and stars (character and figure data) may be input. These lines connecting coordinate point sequences and character and figure data input from the marker operation button group 49 (write button 492, erase button 493, and edit button 494) are referred to as “handwritten data.”

The worker writes additional information that the worker wants to leave in relation to the measurement point x1 as handwritten data into a space through the display 57 by using the write button 492, the erase button 493, and the edit button 494. At this time, when the worker presses the zoom button 592 of the eyewear device 5, a magnification of the image centered at the camera of the imaging section 58 is changed, and the vicinity of the measurement point x1 is enlarged or reduced and displayed. An image obtained by synthesizing handwritten data written at coordinates of the tip end port 4b of the electronic marker 4 by an operation of the marker operation button group 49 with an image imaged by the imaging section 58 of the eyewear device 5 is referred to as “handwritten data synthesized image (reference sign 571 in FIG. 6B).”

When the worker finishes writing handwritten data and presses the image save button 591, the eyewear device 5 transmits a final form of the handwritten data synthesized image 571 to the processing device 3.

The image analyzing section 36 of the processing device 3 recognizes and extracts characters and symbols from the handwritten data synthesized image 571 by, for example, a known OCR (Optical Character Recognition) processing. The processing device 3 acquires text data of the extracted characters and symbols as one of additional data concerning the measurement point x1.

1-7-3. Management of Survey Information

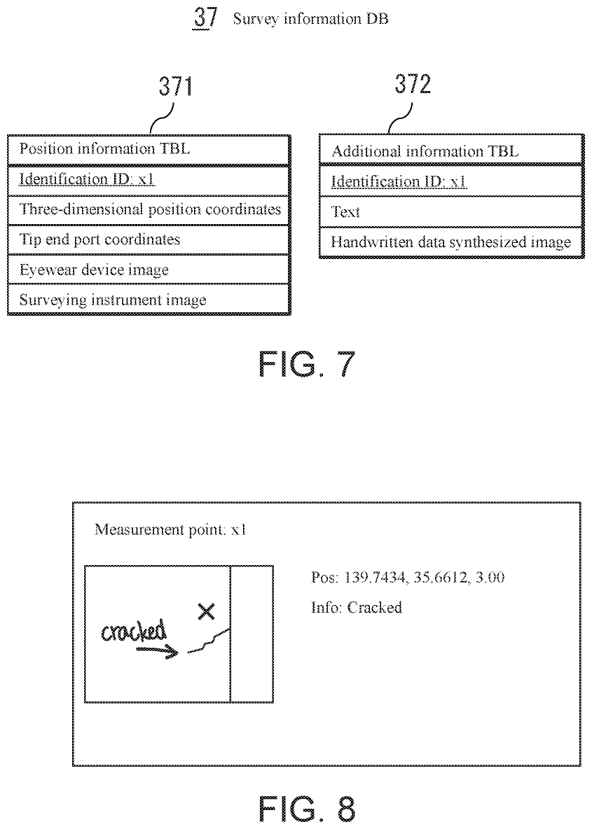

FIG. 7 is a diagram illustrating an example of a survey information database. The processing device 3 stores three-dimensional position data (three-dimensional position coordinates of latitude, longitude, and elevation) of the measurement point x1 acquired in “1-7-1. Acquisition of three-dimensional position” described above in the position information table 371 of the survey information database 37. In addition, in the position information table 371, information (coordinates of the tip end port 4b, the image acquired by the surveying instrument 2, and the image acquired by the eyewear device 5 (not the handwritten data synthesized image)) used for acquiring the three-dimensional position data are also stored by being associated with an identification ID.

The processing device 3 stores additional data (text data, the image acquired by the eyewear device 5 (the handwritten data synthesized image 571)) of the measurement point x1 acquired in “1-7-2. Acquisition of additional data” described above in the additional information table 372 by being associated with the identification ID of the measurement point x1.

1-7-4. Utilization of Survey Information

When the administrator logs in to a dedicated webpage for survey information management by the processing device 3, the administrator can access information of the survey information database 37. The administrator can browse survey information on, for example, the measurement point x1, for example, as illustrated in FIG. 8. FIG. 8 illustrates an example of a management screen for the measurement point x1 to be displayed on the display section 34 of the processing device 3. On the management screen for the measurement point x1, position information (three-dimensional position data: Pos) of the measurement point x1, handwritten data (text data: Info) that the worker wrote at the measurement point x1, and an image of the measurement point x1 (the handwritten data synthesized image 571) are displayed on one screen.

(Effect)

As described above, according to the present embodiment, with respect to a measurement point measured by a worker, an administrator can collectively manage three-dimensional position data and additional data related to the survey. In particular, a landscape of the measurement point that the worker actually viewed and notes written by the worker can be stored as an image and text data, so that post-processing after the survey and evidence management can be easily performed.

### 2. MODIFICATION

The embodiment described above can be preferably modified as follows.

Modification 1

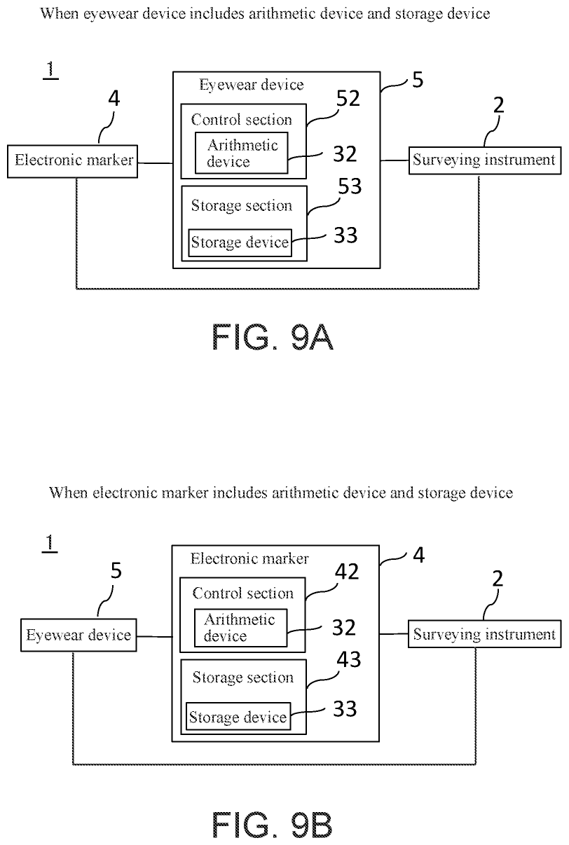

In the embodiment described above, in terms of acquisition of additional data, the managing system 1 includes three elements of the processing device 3, the electronic marker 4, and the eyewear device 5, and the processing device 3 includes the arithmetic device 32 and the storage device 33. However, it is also possible that the electronic marker 4 or the eyewear device 5 includes the arithmetic device 32 (synchronizing section 35 and image analyzing section 36) and the storage device 33 (survey information database 37). FIG. 9A illustrates a configuration in which the control section 52 of the eyewear device 5 includes the arithmetic device 32, and the storage section 53 includes the storage device 33. FIG. 9B illustrates a configuration in which the control section 42 of the electronic marker 4 includes the arithmetic device 32, and the storage section 43 includes the storage device 33. Alternatively, although not illustrated, the electronic marker 4 and the eyewear device 5 can communicate with each other, so that a combination in which the electronic marker 4 includes the arithmetic device 32, and the eyewear device 5 includes the storage device 33, is possible. In this way, in terms of acquisition of additional data, the managing system 1 may consist of two elements of the electronic marker 4 and the eyewear device 5. In this case, a management screen that is displayed on the display section 34 of the processing device 3 is displayed on the eyewear device 5.

An embodiment and a modification of the managing system 1 have been described above, and besides these, the embodiment and the modification can be combined based on the knowledge of a person skilled in the art, and such a combined embodiment is also included in the scope of the present invention.

### REFERENCE SIGNS LIST

1 Managing system
2 Surveying instrument
2′ Distance-measuring light
21, 22 Angle-measuring section
23, 24 Drive section
27 Imaging section
28 Distance-measuring section
29 Communication section
3 Processing device
31 Communication section
32 Arithmetic device
33 Storage device
34 Display section
35 Image analyzing section
36 Synchronizing section
37 Survey information database
371 Position information table
372 Additional information table
4 Electronic marker
4b Tip end port
41 Communication section
42 Control section
44 Accelerometer (posture sensor)
Gyro sensor (posture sensor)
46 GPS device (position sensor)
49 Marker operation button group
5 Eyewear device
51 Communication section
52 Control section
53 Storage section
54 Accelerometer (posture sensor)
55 Gyro sensor (posture sensor)
56 GPS device (position sensor)
57 Display
58 Imaging section

1. A survey information managing system comprising:
an electronic marker to be used near a measurement point by a worker, including a position sensor, a posture sensor, a communication section, and a marker operation button group for inputting handwritten data;
an eyewear device to be worn on the head of the worker, including a display configured to cover the eyes of the worker, an imaging section configured to perform imaging in a line-of-sight direction of the worker, a position sensor, a posture sensor, and a communication section;
an arithmetic device configured to communicate with the electronic marker and the eyewear device, synchronize positions and postures of the electronic marker and the eyewear device, cause the display to display a handwritten data synthesized image obtained by synthesizing the handwritten data written at coordinates of a tip end port of the electronic marker by operation of the marker operation button group with an image imaged by the imaging section of the eyewear device, and apply OCR processing to the handwritten data synthesized image; and
a storage device configured to store the handwritten data synthesized image and text data extracted by the OCR processing from the handwritten data synthesized image, as additional data of the measurement point.

2. The survey information managing system according to claim 1, further comprising:
a surveying instrument including a distance-measuring section capable of performing a non-prism distance measuring of the measurement point by distance-measuring light, an imaging section configured to perform imaging in an optical axis direction of the distance-measuring light, an angle-measuring section configured to measure a vertical angle and a horizontal angle at which the distance-measuring section is oriented, a drive section configured to drive the vertical angle and the horizontal angle of the distance-measuring section to set angles, and a communication section, wherein
the surveying instrument acquires three-dimensional position data of the measurement point, and
for the same measurement point, the storage device stores the three-dimensional position data and the additional data by associating these data with the same identification ID.

3. The survey information managing system according to claim 2, further comprising:
a display section, wherein
on the display section, as survey information of the measurement point, the three-dimensional position data, the text data, and the handwritten data synthesized image are displayed on one screen.
